(19) United States
(12) Patent Application Publication
(10) Pub. No.: US 2024/0300133 A1
(43) Pub. Date: Sep. 12, 2024

(54) CUTTING DEVICE AND CUTTING METHOD

(71) Applicant: SEIKO EPSON CORPORATION, Tokyo (JP)

(72) Inventor: Makoto YOSHIDA, Matsumoto (JP)

(21) Appl. No.: 18/594,061

(22) Filed: Mar. 4, 2024

(30) Foreign Application Priority Data
Mar. 6, 2023 (JP) 2023-033521

(51) Int. Cl. B26D 5/20; B26D 1/16

(52) U.S. Cl. CPC B26D 5/20; B26D 1/165

(57) ABSTRACT

A cutting device includes a cutter configured to cut a web including at least accumulated fibers and a ball screw mechanism configured to move the cutter in a transportation direction of the web, and the cutter, when the web is being transported, cuts the web in a direction intersecting the transportation direction while being moved in the transportation direction of the web by the ball screw mechanism.

The present application is based on, and claims priority from JP Application Serial Number 2023-033521, filed Mar. 6, 2023, the disclosure of which is hereby incorporated by reference herein in its entirety.

### BACKGROUND

### 1. Technical Field

The present disclosure relates to a cutting device and a cutting method.

### 2. Related Art

A cutting device configured to be disposed on a transportation path along which a fiber material is transported and configured to cut the fiber material is known (see, for example, JP-A-2019-085264). JP-A-2019-085264 discloses a sheet recycling technology in a dry method for regenerating sheets from a web including accumulated fibers and a cutting device that does not move in the transportation direction. In a disclosed configuration, a cutting device that cuts a wet-tissue parent paper roll in a direction intersecting the transportation direction is moved in the transportation direction by a crank mechanism (see, for example, JP-A-2003-305685).

To build a cutting device for cutting a web, the crank mechanism in JP-A-2003-305685 enables a web to be cut in a direction intersecting the transportation direction without interrupting the transportation of the web. However, the longer the transportation distance during the cutting operation, the larger the crank mechanism, which requires a large placement space. Hence, it is difficult to achieve a design that enables a web to be cut without interrupting the transportation of the web but requires a less placement space even when the transportation distance during the cutting operation is long.

### SUMMARY

An aspect of the present disclosure is a cutting device configured to be disposed on a transportation path along which a web including at least accumulated fibers is transported and configured to cut the web, the cutting device including: a cutter configured to cut the web; and a ball screw mechanism configured to move the cutter in a transportation direction of the web, in which the cutter, when the web is being transported, cuts the web in a direction intersecting the transportation direction while being moved in the transportation direction of the web by the ball screw mechanism.

An aspect of the present disclosure is a cutting method using a cutting device disposed on a transportation path along which a web including at least accumulated fibers is transported and including a cutter configured to cut the web and a ball screw mechanism configured to move the cutter in a transportation direction of the web, the cutting method including cutting the web with the cutter, when the web is being transported, in a direction intersecting the transportation direction while the ball screw mechanism is moving the cutter in the transportation direction of the web.

### BRIEF DESCRIPTION OF THE DRAWINGS

FIG. 1 is an outline configuration diagram of a sheet manufacturing apparatus including a cutting device according to the present embodiment.

FIG. 2 is a diagram illustrating the cutting device together with a transportation path of a second web.

FIG. 3 is a diagram illustrating the operation of the cutting device in time series.

FIG. 4 is a diagram illustrating operation continued from FIG. 3.

FIG. 5 is a diagram illustrating operation continued from FIG. 4.

FIG. 6 is a diagram illustrating the states of the cutting device in steps S2 to S4 in FIGS. 3 and 4 as viewed in a different direction.

### DESCRIPTION OF EMBODIMENTS

Hereinafter, an embodiment of the present disclosure will be described with reference to the drawings.

### 1. Configuration of Sheet Manufacturing Apparatus

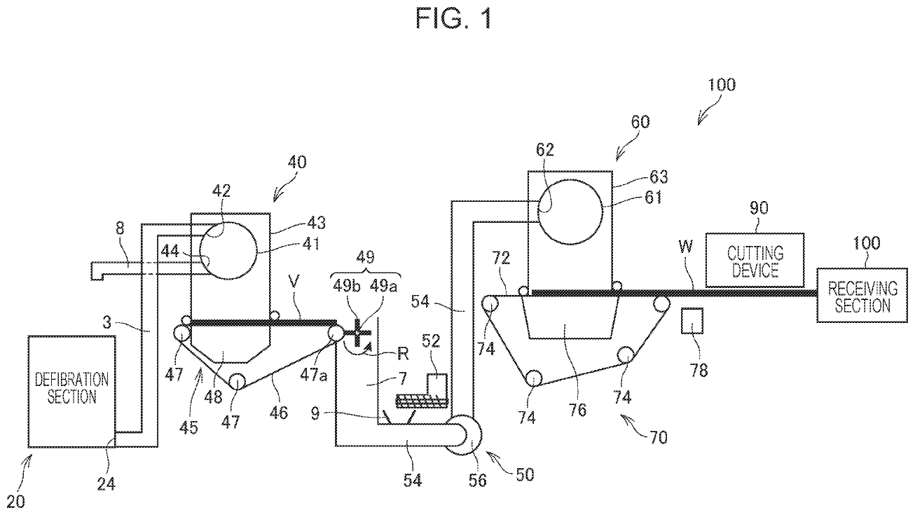

FIG. 1 is an outline configuration diagram of a sheet manufacturing apparatus 10 including a cutting device according to the present embodiment. The sheet manufacturing apparatus 10 is configured to perform a sheet recycling process in a dry process by defibrating a raw material containing fibers, accumulating the defibrated material to form a web, and regenerating or manufacturing sheets from the web. Examples of raw materials containing fibers include paper, pulp, pulp sheets, cloth including nonwoven fabrics, and woven fabrics. Note that the web includes at least a fiber material including accumulated fibers. The web may include, in addition to the fiber material, holding layers in the form of thin films located on both of the upper and lower sides of the fiber material. Note that the fiber material may contain functional powders having properties such as a hygroscopic property. As illustrated in FIG. 1, the sheet manufacturing apparatus 10 includes a defibration section 20, a screening section 40, a first web-formation section 45, a rotator 49, a mixing section 50, an accumulation section 60, a second web-formation section 70, and a cutting device 90.

The sheet manufacturing apparatus 10 has a receiving section 100 located downstream of the cutting device 90 and configured to receive pieces of the web cut by the cutting device 90. The receiving section 100 is, for example, a sheet forming device that forms sheets from cut pieces of the web, more specifically, a device that performs pressing, heating, and the like on the web to form sheets. Note that the receiving section 100 is not limited to a sheet forming device. For example, when a sheet forming device is disposed away from the cutting device 90, the receiving section 100 may be a storage device that temporarily stores the web.

The defibration section 20 defibrates cut raw material. The raw material, for example, is cut into small pieces in a gas such as air and is then supplied to the defibration section 20. The raw material may be used material such as waste paper, or may be fresh material. Waste paper denotes so-called used paper. The term “defibrating” denotes unraveling raw material in which a plurality of fibers are bound, into individual fibers. The raw material refers to coarsely crushed pieces or sometimes refers to material for defibration. The defibration section 20 also has a function of separating substances such as resin particles, ink, toner, and anti-bleed agents attached to the raw material from the fibers.

The material obtained by defibration in the defibration section 20 corresponds to defibrated material. Defibrated material contains not only unraveled fibers but sometimes also contains resin particles separated from fibers when the fibers are unraveled, coloring agents such as ink and toner, and additives such as anti-bleed agents and paper strengthening agents. The defibrated material is in the form of strings. Defibrated material may be in a state of not being tangled with other unraveled fibers, in other words, in a separate state, or it may be in a clumped state in which defibrated material is tangled with other unraveled fibers, in other words, in a state in which clumps are formed.

The defibration section 20 performs defibration as a dry process. Performing a process such as defibration, accumulation, and the like not in a liquid but in a gas such as air is referred to as a dry process. The defibration section 20 is configured to perform defibration by using, for example, an impeller mill but not is limited to this configuration. The defibration section 20 has a function of generating an air flow for sucking the raw material cut into small pieces and discharging the defibrated material. With this function, the defibration section 20 transports the defibrated material to an outlet 24 by using the air flow generated by the defibration section 20. The defibrated material is transported to the screening section 40 through a pipe 3. The air flow for transporting the defibrated material from the defibration section 20 to the screening section 40 is not limited to the air flow generated by the defibration section 20. An air-flow generation device such as a blower may be provided, and the generated air flow may be used.

The screening section 40 receives the defibrated material through an inlet 42 and screens the defibrated material according to fiber length. Although the configuration of the screening section 40 is not particularly limited, the screening section 40 of the present embodiment includes a drum 41 and a housing 43 that houses the drum 41. The drum 41 may employ, for example, a cylindrical sieve rotationally driven by a motor. The drum 41 includes a net and is capable of separating fibers or particles smaller than the size of the mesh of the net, in other words, a first screened material that passes through the net, from fibers, undefibrated scraps, and clumps larger than the size of the mesh of the net, in other words, a second screened material that does not pass through the net. The first screened material is transported to the accumulation section 60 through a pipe 7. The second screened material is returned to the defibration section 20 through an outlet 44 and a pipe 8.

The first screened material having passed through the screening section 40 is transported to the pipe 7. The first web-formation section 45 in the illustrated example includes a mesh belt 46, tension rollers 47, and a suction mechanism 48, but is not limited to this configuration.

The suction mechanism 48 is configured to draw the first screened material having passed through the openings of the screening section 40 and dispersed in air, onto the mesh belt 46. The first screened material is accumulated on the moving mesh belt 46 and forms a web V. The basic configurations of the mesh belt 46, the tension rollers 47, and the suction mechanism 48 are the same as or similar to those of a mesh belt 72, tension rollers 74, and a suction mechanism 76 in the second web-formation section 70 described later.

The web V, which is formed of the material having passed through the screening section 40 and the first web-formation section 45, contains a large amount of air and is soft and puffy. The web V accumulated on the mesh belt 46 is input into the pipe 7 and is transported to the accumulation section 60.

The rotator 49 cuts the web V by its rotation. Although the configuration of the rotator 49 is not particularly limited, the rotator 49 in the present embodiment includes a base 49a and a plurality of protrusions 49b protruding radially from the base 49a. Each protrusion 49b is in the form of, for example, a plate-shaped blade. By the base 49a rotating in the direction R in FIG. 1, the protrusions 49b rotates on the base 49a and can cut the web V.

The rotator 49 is located near a tension roller 47a located downstream on the path of the web V and thus located downstream of the first web-formation section 45. The rotator 49 is located at a position where the protrusions 49b can come into contact with the web V and do not come into contact with the mesh belt 46 on which the web V is accumulated.

The mixing section 50 mixes the first screened material having passed through the screening section 40 and additives. The mixing section 50 includes an additive supply portion 52 that supplies additives, a pipe 54 that transports the first screened material and the additives, and a blower 56. The additives are supplied from the additive supply portion 52 via a hopper 9 into the pipe 54. The pipe 54 is continuous with the pipe 7.

In the mixing section 50, the blower 56 generates an air flow, which transports the first screened material and the additives while mixing them in the pipe 54. Note that the configuration for mixing the first screened material and the additives is not particularly limited and is, for example, one that performs stirring with high-speed rotary blades or one that utilizes the rotation of a container, such as a V blender.

The additive supply portion 52 has a configuration in which, for example, the additives are supplied by using a screw feeder or a disk feeder, but is not limited to this configuration. An additive supplied from the additive supply portion 52 is, for example, a binder for binding a plurality of fibers. Depending on the type of sheet to be manufactured, the additives supplied from the additive supply portion 52 may include a coloring agent for coloring fibers, an aggregation inhibitor for inhibiting aggregation of fibers and additives, and a flame retardant for reducing flammability of fibers. The mixture having passed through the mixing section 50 is transported to the accumulation section 60 through the pipe 54.

The accumulation section 60 receives the mixture having passed through the mixing section 50 through an inlet 62, unravels tangled defibrated material, and causes the mixture to fall in air while dispersing the mixture. The accumulation section 60 causes the defibrated material to be accumulated in a dry process and forms a second web W composed of a soft web. As described above, the second web W formed by the accumulation section 60 is an uncompressed fiber material.

In addition, when a resin supplied from the additive supply portion 52 as an additive is in the form of fibers, the accumulation section 60 unravels tangled resin fibers. This operation enables the accumulation section 60 to accumulate the mixture uniformly on the second web-formation section 70. Although the configuration of the accumulation section 60 is not particularly limited, the accumulation section 60 of the present embodiment includes a drum 61 and a housing 63 that houses the drum 61. The drum 61 employs, for example, a cylindrical sieve rotationally driven by a motor. The drum 61 has a net, which enables fibers or particles smaller than the size of the mesh of the net, contained in the mixture having passed through the mixing section 50 to fall.

Note that the sieve of the drum 61 is not limited to having a function of screening a specific target substance. In other words, the sieve used as the drum 61 denotes a member with a net, and hence, the drum 61 may allow all of the mixture introduced into the drum 61 to fall.

The second web-formation section 70 causes the passed-through material having passed through the accumulation section 60 to accumulate and form a second web W and also serves as at least part of the transportation path for transporting the second web W. Although the configuration of the second web-formation section 70 is not particularly limited, the second web-formation section 70 in the present embodiment includes the mesh belt 72, the tension rollers 74, and the suction mechanism 76.

The passed-through material having passed through the openings of the accumulation section 60 accumulates on the mesh belt 72. The mesh belt 72 is stretched on the tension rollers 74 and configured in a manner such that it is difficult for the passed-through material to pass through and easy for air to pass through. The mesh belt 72 is moved by the rotation of the tension rollers 74. While the mesh belt 72 is continuously moving, the passed-through material having passed through the accumulation section 60 continuously falls onto the mesh belt 72, forming a soft uncompressed second web W.

The suction mechanism 76 is located under the mesh belt 72 and configured to suck the passed-through material dispersed in air by the accumulation section 60, onto the mesh belt 72 and promotes formation of the second web W. This configuration enables an increase in the speed of discharge from the accumulation section 60 and forms a downflow in the falling path of the mixture to prevent the defibrated material and the additives from tangling while falling.

The second web W, which is formed of the material having passed through the accumulation section 60 and the second web-formation section 70 as described above, contains a large amount of air and is soft and uncompressed. The cutting device 90 is located on the transportation path of the second web W and configured to cut the web W being transported. Note that the sheet manufacturing apparatus 10 may include a moisture addition section for adding moisture to the defibrated material in some cases. The moisture addition section is capable of adjusting the water content of the second web W within a specified range to bond a plurality of fibers contained in the defibrated material by hydrogen bonding.

### 2. Configuration of Cutting Device

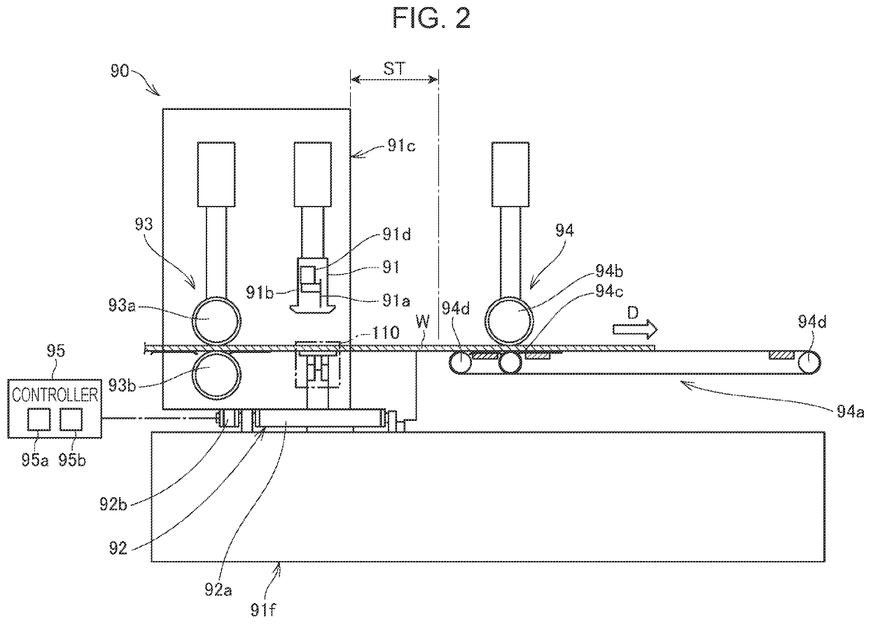

FIG. 2 is a diagram illustrating the cutting device 90 together with the transportation path of the second web W. The symbol D in FIG. 2 indicates the transportation direction of the second web W. The cutting device 90 includes a cutter unit 91, a ball screw mechanism 92, an upstream transportation mechanism 93, a downstream transportation mechanism 94, and a controller 95 that controls the operation of the cutting device 90. The cutter unit 91 includes a cutter 91a for cutting the second web and a cutter movement mechanism 91b that moves the cutter 91a, and these are supported above the second web W by a movable frame 91c.

The cutter 91a is a blade used to cut the second web W in the width direction of the second web W and is a rotary blade having a diameter shorter than the entire width of the second web W in the present embodiment. The cutter 91a is rotationally driven by a motor 91d for the cutter, supported by the movable frame 91c. The cutter movement mechanism 91b is configured to move the cutter 91a in the up-down direction and the right-left direction. Note that the up-down direction and the right-left direction are directions based on the cutting device 90. The up-down direction corresponds to the direction in which the cutter 91a is moved toward and away from the second web W, and the right-left direction corresponds to the width direction of the second web W, in other words, the cutting direction of the second web W.

Although the configuration of the cutter movement mechanism 91b is not particularly limited, for example, the cutter movement mechanism 91b includes a combination of publicly-known mechanisms such as a linear reciprocating mechanism including a rack & pinion and a mechanism including a linear actuator. The movable frame 91c includes a combination of a pillar member extending in the up-down direction and a cross beam extending in the horizontal direction and supports the upstream transportation mechanism 93 in addition to the cutter unit 91. This movable frame 91c is supported by a base frame 91f functioning as the base of the cutting device 90 and functions as a movable table that is moved by the ball screw mechanism 92 in the transportation direction of the second web W relative to the base frame 91f.

The ball screw mechanism 92 is located below the transportation path of the second web W and supported by the base frame 91f. The ball screw mechanism 92 includes a ball screw 92a extending in the transportation direction of the second web W, and the ball screw 92a is rotationally driven by a motor 92b for the ball screw, located on one end side of the ball screw 92a. Note that the movable frame 91c is supported movably in the transportation direction of the second web W and the opposite direction by, for example, a linear motion guide and is coupled to a nut unit coupled to the ball screw 92a in a manner of thread engagement. When the nut unit, along with the rotation of the ball screw 92a, moves in the axis direction of the ball screw 92a, in other words, the transportation direction of the second web W or the opposite direction, the movable frame 91c moves in the transportation direction of the second web W or the opposite direction. The position, the movement direction, and the moving speed of the movable frame 91c are controlled by controlling the rotation angle, the rotation direction, and the rotation speed of the ball screw 92a. The symbol ST in FIG. 2 indicates the movement range, in other words, the movement stroke, of the movable frame 91c.

The upstream transportation mechanism 93 is located upstream of the cutter 91a and includes upper and lower transportation rollers 93a and 93b facing each other with the second web W interposed therebetween. By at least one of the upper and lower transportation rollers 93a and 93b being rotationally driven, the second web W between the transportation rollers 93a and 93b can be transported in the transportation direction. Each of the transportation rollers 93a and 93b is a rotational roller extending across the entire width of the second web W. The upper transportation roller 93a is movable in the up-down direction so as to move toward and away from the second web W. Since the cutter unit 91, the upstream transportation mechanism 93, driving sources for driving these units, and the like are supported by the movable frame 91c, these units move together in the transportation direction of the second web W and the opposite direction.

The downstream transportation mechanism 94 is located downstream of the cutter 91a and supported by the base frame 91f of the cutting device 90. The downstream transportation mechanism 94 includes a belt mechanism 94a located on the lower side of the second web W, which corresponds to one side when the second web W is pinched, and a transportation roller 94b located on the upper side of the second web W, which corresponds to the other side when the second web W is pinched. The belt mechanism 94a includes a belt 94c extending across the entire width of the second web W and a set of rollers 94d including a driving roller that transports the belt 94c and a driven roller, and when the driving roller rotates for driving, the belt 94c moves in the transportation direction of the second web W.

The transportation roller 94b is a rotational roller extending across the entire width of the second web W and is movable in the up-down direction so as to move toward and away from the second web W. When the transportation roller 94b is at a lower position, the transportation roller 94b and the belt mechanism 94a pinch the second web W. When the belt mechanism 94a and the transportation roller 94b pinching the second web W are driven, the second web W between the belt mechanism 94a and the transportation roller 94b can be transported in the transportation direction.

The controller 95 has a function of controlling each unit of the cutting device 90 and controls at least the motors and the like serving as the driving sources of the cutter unit 91, the ball screw mechanism 92, the upstream transportation mechanism 93, and the downstream transportation mechanism 94. The controller 95 includes a processor 95a and memory 95b. The processor 95a is an arithmetic processing device including a central processing unit (CPU), a micro-processing unit (MPU), or the like. The memory 95b is a storage device such as read only memory (ROM), flash memory, and electrically erasable programmable read-only memory (EEPROM) and stores data including a control program.

In the controller 95, the processor 95a executes a control program stored in the memory 95b. With this operation, the controller 95 loads instructions and information on transportation and cutting of the second web W, and controls operation of each unit in the cutting device 90 in synchronization with the transportation of the second web W by using a publicly-known motion control technique.

The processor 95a may be composed of a single processor or a plurality of processors. Alternatively, the processor 95a may be part of an SoC integrally including part or all of the memory 95b and other circuits. The processor 95a may be composed of a combination of a CPU that executes programs and a digital signal processor (DSP) that executes specified arithmetic processing. All of the functions of the processor 95a may be implemented by hardware or may be implemented by a programable device.

### 3. Operation of Cutting Device

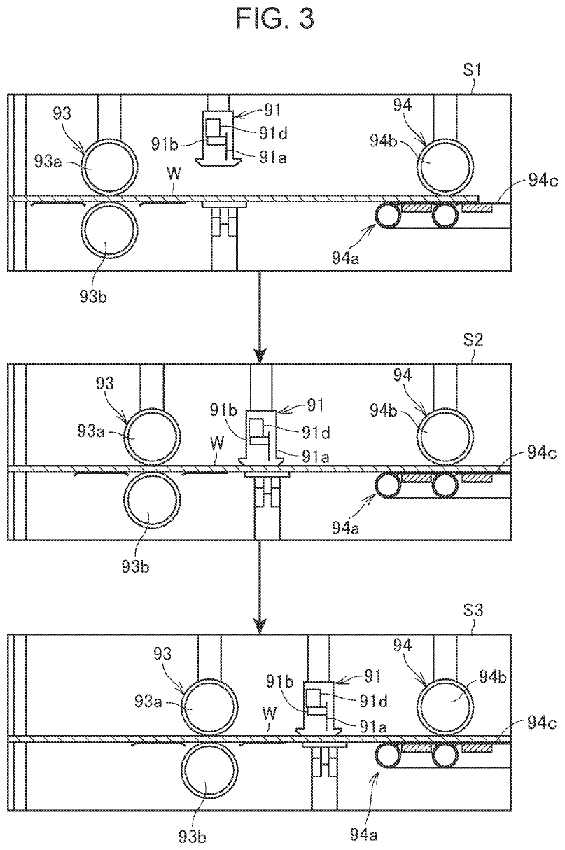

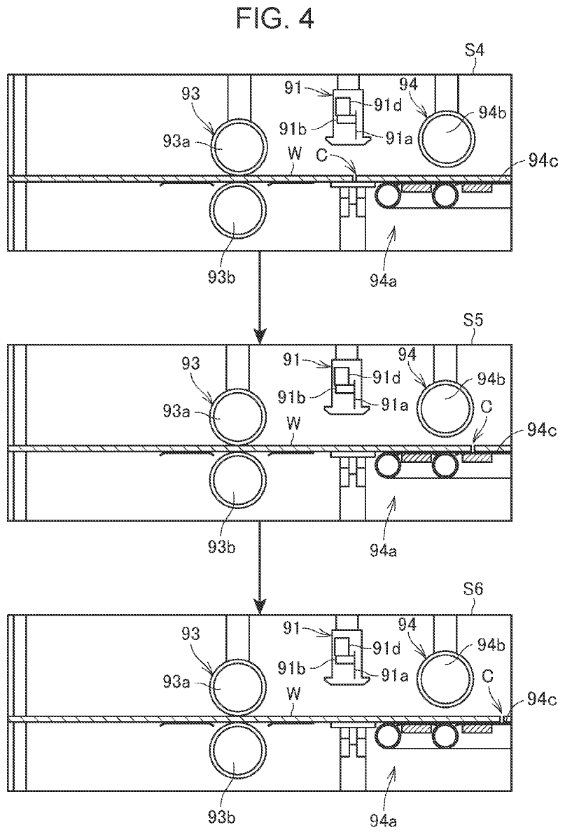

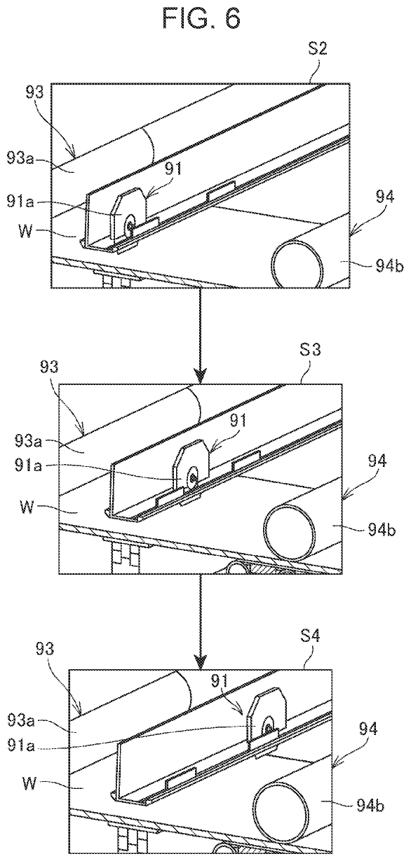

FIGS. 3 to 5 are diagrams illustrating the operation of the cutting device 90 in time series. FIG. 6 is a diagram illustrating the states of the cutting device 90 in steps S2 to S4 in FIGS. 3 and 4 as viewed in a different direction. In the present embodiment, the second web W is transported continuously. Hence, transportation of the second web W toward the cutting device 90 is not interrupted, and the second web W continues to be transported at a predetermined transportation speed.

Step S1 in FIG. 3 illustrates the cutting device 90 before starting cutting operation. In step S1, the controller 95 holds the cutter unit 91 at an upper position which is away from the second web W and also at the upstream position of a movement stroke ST by using the ball screw mechanism 92. The controller 95 also moves the movable upper transportation roller 93a of the upstream transportation mechanism 93 to a lower position where the upper transportation roller 93a is in contact with the second web W and rotationally drives the transportation roller 93a until the ball screw mechanism 92 starts to operate. In addition, the controller 95 moves the movable upper transportation roller 94b of the downstream transportation mechanism 94 to a lower position where the upper transportation roller 94b is in contact with the second web W, and drives the belt mechanism 94a and the transportation roller 94b to transport the second web W downstream.

When the second web W reaches a cutting start position where cutting operation of the cutter unit 91 starts, the controller 95, as illustrated in steps S2 and S3 in FIG. 3, causes the ball screw mechanism 92 to move the cutter unit 91 at the same speed as that of the second web W in the transportation direction, and in synchronization with this movement, moves down the cutter unit 91 to start cutting the second web W. Note that during this operation, the transportation rollers 93a and 93b are stopped. In this operation, as illustrated in FIG. 6, the controller 95 moves the cutter 91a from one side to the other side of the second web W in the width direction while rotationally driving the cutter 91a.

Since the cutter 91a moves at the same speed as the transportation speed while the cutter 91a is moving across the entire width of the second web W, the transportation of the second web W is not interrupted, and the second web W is cut in a straight line in the width direction. In this operation, the controller 95 causes at least both the belt mechanism 94a and the transportation roller 94b of the downstream transportation mechanism 94 to continue transporting the second web W at least until cutting of the second web W is completed and the cutter 91a retreats upward.

When the cutting of the second web W is completed, the controller 95 stops driving the ball screw mechanism 92 and, as illustrated in step S4 in FIG. 4, moves up the cutter unit 91 to a position away from the second web W. As illustrated in steps S4 and S5 in FIG. 4, the controller 95 moves up the upper transportation roller 94b of the downstream transportation mechanism 94 so that the cut portion C of the second web W will not come into contact with the transportation roller 94b. During these steps S4 and S5, the second web W continues being transported by the upstream transportation mechanism 93, and the belt mechanism 94a of the downstream transportation mechanism 94.

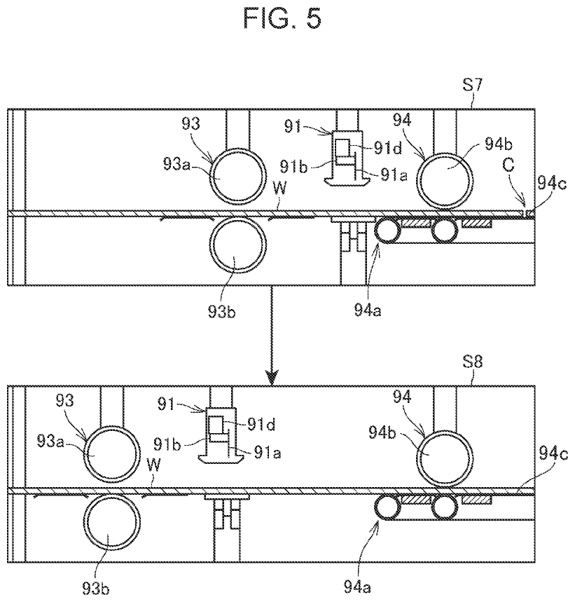

When the cut portion C of the second web W passes by the position of the transportation roller 94b, the controller 95 starts control such that the downstream transportation mechanism 94 causes the second web W upstream of the cut portion C to push out the cut piece of the second web W downstream in the transportation direction. This control to push out is referred to as “cut-web push-out control”, the operation of which is illustrated in steps S6 to S8 in FIGS. 4 and 5. In this cut-web push-out control, the upper transportation roller 94b is moved down, and the second web W upstream of the cut portion C is pinched by the belt mechanism 94a and the transportation roller 94b. Both the belt mechanism 94a and the transportation roller 94b are rotated in a specified period.

This operation enables the cut piece of the second web W to be pushed out downstream by the second web W upstream of the cutting position. The pushed-out piece of the second web W is transported downstream by the belt mechanism 94a extending to a position downstream of the transportation roller 94b. The specified period is set in advance to be a period until the receiving section 100 located downstream holds the cut piece of the second web W. This ensures that the receiving section 100 receives the cut piece of the second web W. Thus, for example, when the receiving section 100 is a sheet forming device, the sheet forming device can smoothly start a process of performing pressing, heating, and the like on the cut piece of the second web W to form a sheet.

Note that during the cut-web push-out control, the controller 95 causes the ball screw mechanism 92 to move the cutter unit 91 in the direction opposite to the transportation direction of the second web W and, as illustrated in step S8 in FIG. 5, moves the cutter unit 91 to the upstream position of the movement stroke ST. While moving the cutter unit 91 to the upstream position of the movement stroke ST, the controller 95 holds the upper transportation roller 93a of the upstream transportation mechanism 93 at an upper position. With this operation, the transportation roller 93a which moves together with the cutter unit 91 does not come into contact with the second web W. The above is a description of the cutting operation. This cutting operation is repeatedly executed at specified timings in synchronization with the transportation of the second web W, so that the second web W is cut into pieces with a specified length.

As described above, the cutting device 90 according to the present embodiment includes the cutter 91a configured to cut the second web W including at least accumulated fibers, the ball screw mechanism 92 configured to move the cutter 91a in the transportation direction of the second web W, and the controller 95 configured to control the operation of the cutter 91a and the ball screw mechanism 92. The controller 95, when transporting the second web W, causes the ball screw mechanism 92 to move the cutter 91a in the transportation direction of the second web W and causes the cutter 91a to cut the second web W in the width direction. With this operation, when the second web W is being transported, the cutter 91a cuts the second web W in the width direction intersecting the transportation direction while the ball screw mechanism 92 causes the cutter 91a to move in the transportation direction of the second web W. This configuration enables the second web W to be cut in a direction intersecting the transportation direction without interrupting the transportation of the second web W. Since the ball screw mechanism 92 is used, even when the transportation distance during the cutting operation is long, it only requires a ball screw mechanism 92 having a long stroke, and a large placement space is not necessary except in the stroke direction. Hence, even when the transportation distance during the cutting operation is long, this configuration makes it possible to save the placement space while the configuration enables the second web W to be cut without interrupting the transportation of the second web W.

Since the cutting device 90 includes the transportation rollers 93a and 93b configured to transport the second web W, holding and transporting the second web W can be performed also on the cutting device 90 side. In addition, since the transportation rollers 93a and 93b press the second web W against the transportation surface moderately, effects of improving transportation and cutting can be obtained.

The transportation roller 93a of the upstream transportation mechanism 93 is a movable roller configured to move away from the second web W, and the movable roller is away from the second web W while the cutter 91a moves upstream in the transportation direction of the second web W. With this configuration, the transportation roller 93a does not hinder the transportation of the second web W while the cutter 91a moves upstream in the transportation direction of the second web W. This configuration enables the transportation roller 93a and the cutter 91a to move together and thus enables the transportation roller 93a and the cutter 91a to be located close to each other.

The downstream transportation mechanism 94 is located downstream of the cutter 91a and configured to transport the second web W after the second web W is cut. This configuration enables the downstream piece of the second web W relative to the cutter 91a to be transported after the second web W is cut. Note that, as illustrated in in step S7 in FIG. 5, the present embodiment illustrates an example in which the cut piece of the second web W is pushed out by transporting the second web W upstream of the cut portion C. However, a configuration in which this transportation roller 94b directly transports the downstream piece of the second web W relative to the cut portion C is possible.

The specified period during which the second web W is transported after the second web W is cut is set to a period until the receiving section 100, which is a downstream section on the receiving side, holds the cut piece of the second web W. This configuration makes it easy for the section on the receiving side to receive the cut piece of the second web W and thus makes it possible to smoothly start the next process, for example, a process of performing pressing, heating, and the like on the cut piece of the second web W to form sheets.

The cutter 91a is movable and configured to move in a direction intersecting the transportation direction of the second web W to cut the second web W across the entire width. This configuration enables a relatively small cutter 91a to cut a second web W with a large width and is thus advantageous to decreasing the size of the portion of the cutter 91a, increasing the degree of freedom of selection of the cutter 91a, increasing the degree of freedom of the width of the second web W, and other factors. In addition, when a smaller cutter 91a is used, or the moving speed of the cutter 91a during the cutting operation is decreased, so that the transportation distance of the second web W during the cutting operation is increased, it is easy to adapt to such setting by changing the movement stroke of the cutter 91a, for example.

The present embodiment is to show an aspect, and hence, the embodiment can be changed and applied in any way within a range not departing from the spirit of the present disclosure. For example, although the description here is based on a case in which the present disclosure is applied to the cutting device 90 used in the sheet manufacturing apparatus 10 illustrated in FIG. 1 and the cutting method using this cutting device 90, the configuration is not limited to this case. The present disclosure is applicable to any cutting device for cutting a web including accumulated fibers and a cutting method using such a cutting device. In addition, the layout, the shapes, and the like of the units in the cutting device 90 may be changed as appropriate, or a configuration not including some of the units may be possible. For example, a cutting device 90 having a configuration not including one of the upstream transportation mechanism 93 and the downstream transportation mechanism 94 is possible within a range in which the second web W can be appropriately cut.

Although the description here is based on a case in which the cutter 91a cuts the second web W in the width direction, the present disclosure is not limited to this case. The present disclosure is applicable to any configuration in which a cutter 91a cuts the second web W in a direction intersecting the transportation direction of the second web W. For example, the cutter 91a may cut the second web W at an angle oblique to the transportation direction.

The operation of the cutting device 90 illustrated in FIGS. 3 to 5 and other figures is an example, and hence, details of the operations, the order of the operations, and the like of the units in the cutting device 90 may be changed as appropriate. The controller 95 is not limited to one dedicated to the cutting device 90, and a controller for another device may also serve as the controller 95. The controller that controls the operations of the cutter 91a, the ball screw mechanism 92, and the like can be changed as appropriate.

### 4. Summary of Present Disclosure

The following shows a summary of the present disclosure as appendixes.

(Appendix 1) A cutting device configured to be disposed on a transportation path along which a web including at least accumulated fibers is transported and configured to cut the web, the cutting device including: a cutter configured to cut the web; and a ball screw mechanism configured to move the cutter in a transportation direction of the web, in which when the web is being transported, the cutter cuts the web in a direction intersecting the transportation direction while being moved in the transportation direction of the web by the ball screw mechanism.

This configuration enables the web to be cut in a direction intersecting the transportation direction without interrupting the transportation of the web. In addition, when the transportation distance during the cutting operation is long, it only requires a ball screw mechanism having a long stroke, and a large placement space is not necessary except in the stroke direction. Hence, even when the transportation distance during the cutting operation is long, this configuration makes it possible to save the placement space while the configuration enables the web to be cut without interrupting the transportation of the web.

(Appendix 2) The cutting device according to Appendix 1, further including a transportation roller configured to transport the web.

This configuration smooths the transportation of the web on the cutting device side.

(Appendix 3) The cutting device according to Appendix 2, in which the transportation roller includes a movable roller configured to move away from the web, and while the cutter is moving upstream in the transportation direction of the web, the movable roller is away from the web.

Since the transportation roller does not hinder the transportation of the web while the cutter is moving upstream in the transportation direction of the web, this configuration enables the transportation roller and the cutter to move together and thus enables the transportation roller and the cutter to be located close to each other.

(Appendix 4) The cutting device according to Appendix 2, in which the transportation roller is located downstream of the cutter and configured to transport the web after the web is cut by rotating for a specified period.

With this configuration, after the web is cut, the downstream piece of the web relative to the cutter can be transported.

(Appendix 5) The cutting device according to Appendix 4, in which the specified period is set to a period until a downstream section on a receiving side holds a cut piece of the web.

This configuration makes it easy for the section on the receiving side to receive the cut piece of the web, making it possible to smoothly start the next process.

(Appendix 6) The cutting device according to any one of Appendixes 1 to 5, in which the cutter is movable and configured to move in a direction intersecting the transportation direction of the web to cut the web across an entire width of the web.

This configuration enables a relatively small cutter to cut a web with a large width and is thus advantageous to decreasing the size of the portion of the cutter, increasing the degree of freedom of selection of the cutter, increasing the degree of freedom of the width of the web, and other factors.

(Appendix 7) A cutting method using a cutting device disposed on a transportation path along which a web including at least accumulated fibers is transported and including a cutter configured to cut the web and a ball screw mechanism configured to move the cutter in a transportation direction of the web, the cutting method including cutting the web with the cutter, when the web is being transported, in a direction intersecting the transportation direction while the ball screw mechanism is moving the cutter in the transportation direction of the web.

Even when the transportation distance during the cutting operation is long, this cutting method makes it possible to save the placement space while the method enables the web to be cut without interrupting the transportation of the web.

What is claimed is:

1. A cutting device configured to be disposed on a transportation path along which a web including at least accumulated fibers is transported and configured to cut the web, the cutting device comprising:
a cutter configured to cut the web; and
a ball screw mechanism configured to move the cutter in a transportation direction of the web, wherein
when the web is being transported, the ball screw mechanism moves the cutter in the transportation direction of the web, and while the cutter is being moved, the cutter cuts the web in a direction intersecting the transportation direction.

2. The cutting device according to claim 1, further comprising
a transportation roller configured to transport the web.

3. The cutting device according to claim 2, wherein
the transportation roller includes a movable roller configured to move away from the web, and
while the cutter is moving upstream in the transportation direction of the web, the movable roller is away from the web.

4. The cutting device according to claim 2, wherein
the transportation roller is located downstream of the cutter and configured to transport the web after the web is cut by rotating for a specified period.

5. The cutting device according to claim 4, wherein
the specified period is set to a period until a downstream section on a receiving side holds a cut piece of the web.

6. The cutting device according to claim 1, wherein
the cutter is movable and configured to move in a direction intersecting the transportation direction of the web to cut the web across an entire width of the web.

7. A cutting method using a cutting device disposed on a transportation path along which a web including at least accumulated fibers is transported and including a cutter configured to cut the web and a ball screw mechanism configured to move the cutter in a transportation direction of the web, the cutting method comprising
cutting the web with the cutter, when the web is being transported, in a direction intersecting the transportation direction while the ball screw mechanism is moving the cutter in the transportation direction of the web.
